(19) United States
(12) Patent Application Publication
(10) Pub. No.: US 2010/0216959 A1
(43) Pub. Date: Aug. 26, 2010

(54) PROCESS FOR PRODUCTION OF PHOTORESIST RESINS

(75) Inventors: Isamu Yonekura, Tokyo (JP); Fumie Honda, Tokyo (JP); Yasuhiro Ito, Tokyo (JP); Masatsugu Niimi, Tokyo (JP)

Correspondence Address: Ditthavong Mori & Steiner, P.C., 918 Prince Street, Alexandria, VA, 22314, US

(73) Assignee: JSR Corporation, Tokyo (JP)

(21) Appl. No.: 12/738,841

(22) PCT Filed: Oct. 21, 2008
(86) PCT No.: PCT/JP2008/069063

§ 371 Date: Apr. 20, 2010

(30) Foreign Application Priority Data
Nov. 12, 2007 (JP) 2007-293668

(51) Int. Cl. C08F 224/00

(52) U.S. Cl. 526/266

(57) ABSTRACT

The object of the present invention is to provide a method for production of a photoresist resin which enables to reduce the amount of solvent used, to remove effectively impurities such as low molecular components and metal components and to prepare easily a resin having a narrow molecular weight distribution. The present invention is a method for production of a photoresist resin by polymerizing a polymerizable compound in the presence of a solvent and the method comprises (1) a resin solution preparation process in which a resin solution containing a photoreist resin is prepared, and (2) a purification process in which the resin solution is purified using a ultrafilter membrane.

### TECHNICAL FIELD

The present invention relates to a method for production of a photoresist resin. More specifically, the present invention relates to a method for production of a photoresist resin which enables to reduce the amount of solvent to be used, to remove effectively impurities such as low molecular components and metal components and to prepare easily a resin having a narrow molecular weight distribution.

### BACKGROUND ART

In the field of micro-processing typified by the manufacture of an integrated circuit element, a lithography technique is required which makes it possible to realize more finely processing. In the conventional lithography process, near ultraviolet rays such as i-rays are commonly applied as radiation, however, it is said that micro-processing for a level to subquarter micron is extremely difficult when the near ultraviolet rays are applied. Accordingly, the use of radiation having a shorter wave length than the near ultraviolet rays has been studied to enable micro-processing for a level to 0.10 μm or smaller. The short wave length radiation may be far ultraviolet rays including bright line spectrum by mercury lamp and excimer laser, X rays, electron beams, or the like. Among these, KrF excimer laser (wavelength 248 nm), and ArF excimer laser (wavelength 193 nm) are of particular interest.

In addition, many kinds of resin compositions used for photolithography, such as a radiation sensitive resin composition for the formation of a resist, a resin composition for the formation of the upper layer film and underlayer film (including anti-reflection film) in a multilayer resist film have been proposed.

The resin contained in the resin composition used for the photolithography is required to have basic properties of a resin for the formation of a coating film wherein impurities are not contained which leads to undesired fine pattern formation, in addition to the optical property expecting a resist film and anti-reflective film, chemical property, and physical properties of applicability, adhesiveness to a substrate or under layer film. If the impurities which are added or produced during polymerization, and are exemplified as an unreacted monomer, polymerization initiator, chain transfer agent, a coupling product thereof and the like, remain in the resin contained in the resin composition, it is possible that the impurities may be volatilized during the lithography process to damage the exposure apparatus, and that a substance that is generated by polymerizing during storage of the resin or the resin composition for lithography and causes pattern defects.

Accordingly, when the resin is prepared, a purification process for removal of the impurities is necessary, and a producing method of a resin comprising a purifying by the reprecipitation, and the like have been conventionally known (see, Patent Document 1, for example).

[Patent Document 1] JP-A 2005-132974

### DISCLOSURE OF THE INVENTION

### Problems that the Invention is to Solve

Nevertheless, according to the conventional producing method of the resin comprising the reprecipitation, in the case where the difference between the solubility of the resin and the solubilities of the monomer or the oligomer component in which 2 to 5 monomers link together is small, separation of the monomer and the oligomer from the resin may be difficult and purification efficiency of the resin is not sufficient. A method for the production of the highly_purified resin having a narrower molecular weight distribution is required. In addition, according to the conventional producing method of the resin comprising the reprecipitation, a poor solvent needs to be added to the polymer solution, so that there is a further problem in that a large amount of solvent is necessary.

The present invention has been achieved in view of this situation. The object of the present invention is to provide a method for production of a photoresist resin which enables to reduce the amount of solvent used, to remove effectively impurities such as low molecular components and metal components and to prepare easily a resin having a narrow molecular weight distribution.

### Means for Solving the Problems

The present invention is as follows.

A method for production of a photoresist resin by polymerizing a polymerizable compound in the presence of a solvent, characterized by comprising,

(1) a resin solution preparation process in which a resin solution containing a photoreist resin is prepared, and
(2) a purification process in which the resin solution is purified using a ultrafilter membrane.
[2] The method for production of a photoresist resin according to [1], wherein the ultrafilter membrane comprises a ceramic.
[3] The method for production of a photoresist resin according to [1] or [2] above, wherein the membrane layer of the ultrafilter membrane comprises TiO₂ or ZrO₂.
[4] The method for production of a photoresist resin according to any one of [1] to [3] above, wherein the average pore size of the ultrafilter membrane is 10 nm or smaller.
[5] The method for production of a photoresist resin according to any one of [1] to [4] above, wherein the purification process comprises a concentration process for concentrating the resin solution while removing impurities in the resin solution using the ultrafilter membrane, and a dilution process for diluting the concentrated resin solution with a solvent, these processes being repeated alternately.
[6] The method for production of a photoresist resin according to any one of [1] to [5] above, wherein the waste solvent produced in the purification process is distilled to separate impurities, after which the resulting waste solvent from which the impurities have been separated is then reused as the solvent.
[7] The method for production of a photoresist resin according to any one of [1] to [4] above, wherein the linear velocity of the resin solution in the ultrafilter membrane during the purification process is 2.5 m/s or smaller.

### Effect of the Invention

According to the method for production of a photoresist resin of the present invention, impurities such as low molecular components and metal components can be effectively removed, and a resin can be easily produced which has a narrow molecular weight distribution and leads to excellent resist performance. Therefore, the present invention is favorably applied in the field of the production of the resin contained in a resin composition used for photolithography, such as a radiation sensitive resin composition for the formation of a resist, a resin composition for the formation of the upper layer film and underlayer film (including anti-reflection film) in a multilayer resist film.

Further, the use of a large amount of the solvent may be unnecessary and the addition of a poor solvent is also not necessary. Accordingly, the consumption of the solvent can be reduced in comparison with the conventional method. Moreover, the waste solvent produced in the purification process can be recovered while separating its impurities by distillation, and the recovered solvent can be reused as a solvent for polymerization and a solvent for dilution. Therefore, the amount of solvent to be used can be more reduced.

Since the resin is very expensive, the polymer recovery should be improved. In the case where the linear velocity of the resin solution in the ultrafilter membrane during the purification process is reduced (for example, 2.5 m/s and smaller), the polymer recovery can be dramatically improved.

### BEST MODE FOR CARRYING OUT THE INVENTION

Hereinafter, the present invention is described in detail. The method for production of a photoresist resin of the present invention is a method of producing a photoresist resin by polymerizing a polymerizable compound in the presence of a solvent, and is characterized by comprising (1) a resin solution preparation process in which a resin solution containing a photoreist resin is prepared, and (2) a purification process in which the resin solution is purified using a ultrafilter membrane.

### [1] Resin Solution Preparation Process

In the resin solution preparation process, a resin solution containing a photoresist resin is prepared by polymerizing a polymerizable compound in the presence of a solvent.

The polymerizable compound may be a polymerizable compound (monomer) having an ethylenical unsaturated bond used in the production of a photoresist resin contained in commonly a resin composition used for photolithography, such as a radiation sensitive resin composition for the formation of a resist, a resin composition for the formation of the upper layer film and underlayer film (including anti-reflection film) in a multilayer resist film.

For instance, the resin contained in a positive type radiation sensitive resin composition used for the formation of a resist forming comprises at least one repeating unit having a chemical structure which is resolved with an acid to be soluble in an alkali developer, and more specifically a repeating unit (1) having a chemical structure that produces a polar group which is soluble in the alkali developer through the dissociation of a nonpolar substituent with an acid, and a repeating unit (2) having a polar group to improve adhesiveness to a substrate such as a substrate for a semiconductor essentially. The resin comprises, if necessary, a repeating unit (3) having a nonpolar substituent to control the solubility of the resin in a solvent or the alkali developer.

The repeating unit (1) which is to be alkali-soluble after resolution with an acid means a chemical structure that is commonly conventionally used for a resist, and the repeating unit can be formed by polymerizing a monomer having a chemical structure which is to be alkali soluble after resolution with an acid, or polymerizing a monomer having alkali soluble chemical structure, and then protecting a substituent having an alkali soluble group (alkali soluble group) in the alkali soluble chemical structure with a group which is insoluble in alkali but is dissociated with an acid (acid dissociative protective radical).

The monomer having a chemical structure which is to be alkali soluble after resolution with an acid may be a compound in which an acid dissociative protective group is bound to a polymerizable compound having an alkali soluble substituent. Example thereof includes a compound having a phenolic hydroxyl group protected with a nonpolar acid dissociative protective group, a carboxyl group or a hydoroxyfluoroalkyl group, and the like.

Specific examples include a hydroxystyrene such as p-hydroxystyrene, m-hydroxystyrene and p-hydroxy-α-methylstyrene; a carboxylic acid having an ethylenic double-bond such as acrylic acid, methacrylic acid, maleic acid, fumaric acid, α-trifluoromethylacrylic acid, 5-norbornene-2-carboxylic acid, 2-trifluoromethyl-5-norbornene-2-carboxylic acid and carboxytetracydo[4.4.0.1^{2,5}.1^{7,10}]dodecyl methacrylate; a polymerizable compound having a hydroxyfluoroalkyl group such as p-(2-hydroxyl-1,1,1,3,3,3-hexafluoro-2-propyl)styrene, 2-(4-(2-hydroxy-1,1,1,3,3,3-hexafluoro-2-propyl)clohexyl)-1,1,1,3,3,3-hexafluoropropyl acrylate, 2-(4-(2-hydroxy-1,1,1,3,3,3-hexafluoro-2-propyl)pcyclohexyl)-1,1,1,3,3,3-hexafluoropropyltrifluoromethyl acrylate and 5-(2-hydroxy-1,1,1,3,3,3-hexafluoro-2-propyl)methyl-2-norbornene; and the like.

Additionally, examples of the acid dissociative protective group include a saturated hydrocarbon group such as tert-butyl group, tert-amyl group, 1-methyl-1-cyclopentyl group, 1-ethyl-1-cyclopentyl group, 1-methyl-1-cyclohexyl group, 1-ethyl-1-cyclohexyl group, 2-methyl-2-adamantyl group, 2-ethyl-2-adamantyl group, 2-propyl-2-adamantyl group, 2-(1-adamantyl)-2-propyl group, 8-methyl-8-tricyclo[5.2.1.0^{2,6}]decanyl group, 8-ethyl-8-tricyclo[5.2.1.0^{2,6}]decanyl group, 8-methyl-8-tetracyclo[4.4.0.1^{2,5}.1^{7,10}]dodecanyl group and 8-ethyl-8-tetracyclo[4.4.0.1^{2,5}.1^{7,10}]dodecanyl group; a hydrocarbon group having oxygen atom such as 1-methoxyethyl group, 2-ethoxyethyl group, 1-isopropoxyethyl group, 1-n-butoxyethyl group, 1-tert-butoxyethyl group, 1-cyclopentyloxyethyl group, 1-cyclohexyloxyethyl group, 1-tricyclo[5.2.1.0^{2,6}]decanyloxyethyl group, methoxymethyl group, ethoxyethyl group, isopropoxymethyl group, n-butoxymethyl group, tert-butoxymethyl group, cyclopentyloxymethyl group, cyclohexyloxymethyl group, tricyclo[5.2.1.0^{2,6}]decanyloxymethyl group and tert-butoxycarbonyl group; and the like.

In the case where a monomer having an alkali soluble chemical structure is polymerized, and then the alkali soluble group in the alkali soluble chemical structure is protected with an acid dissociative protective group, the compound having the alkali soluble chemical structure is used for polymerization as it is and is subjected to reaction with a compound which provides an alkali insoluble substituent such as vinyl ether and a halogenated alkylether in the presence of an acid catalyst to introduce an acid dissociative protective group. Examples of the acid catalyst used in the reaction include p-toluenesulfonic acid, trifluoroacetic acid, a strong acid cation resin and the like.

Additionally, examples of the monomer providing the repeating unit (2) having a polar group to improve adhesiveness to a substrate include a compound having a polar group such as phenolic hydroxide group, carboxyl group and hydroxyl fluoroalkyl group, and the like Specific example thereof includes a hydroxy styrene, a carboxylic acid having an ethylenic double bond, and a polymerizable compound having a hydroxyl fluoroalkyl group that are exemplified as the polymerizable compound having an alkali soluble group; a monomer in which the above-mentioned compound has a polar group by substitution; a monomer in which an alicyclic structure such as norbornene ring and tetracyclodecene ring is bound to a polar group; and the like.

The polar group to be introduced into the repeating unit (2) as the substituent is particularly preferably a group containing a lacton structure. Example thereof include a substituent containing a lacton structure such as γ-butyrolactone, γ valerolactone, δ-valerolactone, 1,3-cyclohexanecarbolactone, 2,6-norbornanecarbolactone, 4-oxatricyclo[5.2.1.0^{2,6}]decane-3-one and mevalonic acid δ-lactone.

In addition, example of the polar group not containing lacton structure includes a hydroxyalkyl group such as hydroxymethyl group, hydroxyethyl group, hydroxypropyl group and 3-hydroxy-1-adamantyl group; and the like.

Further, examples of the monomer providing the repeating unit (3) having a nonpolar substituent to control the solubility of the resin in a solvent for a resist or the alkali developer that is contained if necessary include an aromatic compound having an ethylenic double bond such as styrene, α-methylstyrene, p-methylstyrene and indene; an ester compound having an acid stable non-polar group by substitution in a carboxylic acid having ethylenic double bond such as acrylic acid, methacrylic acid, trifluoromethylacrylic acid, norbornenecarboxylic acid and carboxytetracyclo[4.4.0.1^{2,5}.1^{7,10}]dodecyl methacrylate; an alicyclic hydrocarbon compound having an ethylenic double bond such as norbornene and tetracyclodecene; and the like.

Examples of the acid stable nonpolar substituent for ester substituting to the carboxylic acid include methyl group, ethyl group, cyclopentyl group, cyclohexyl group, isobornyl group, tricyclo[5.2.1.0^{2,6}]decanyl group, 2-adamantyl group, tetracyclo [4.4.0.1^{2,5}.1^{7,10}]dodecyl group and the like.

For the repeating unit (1), (2), and (3), the above-mentioned monomer may be used singly or in combination of two or more types thereof.

The ratio of the repeating units in the resin contained in the positive type radiation sensitive resin composition for the formation of a resist may be selected so as to be in an arbitrary range, in so far as the fundamental performance as a resist is not lost. Generally, the content of the repeating unit (1) is preferably in the range from 10% to 70% by mol, and more preferably from 10% to 60% by mol. The content of the repeating unit (2) is preferably in the range from 30% to 90% by mole, and more preferably from 40% to 90% by mol, but in a case where the monomer units in the repeating unit (2) are of the same polar group, the content thereof is preferably 70% or less by mol. Additionally, the content of the repeating unit (3) is preferably 50% or less by mol, and more preferably 40% or less by mol.

On the other hand, as the resin contained in the resin composition for the formation of the upper layer film and underlayer film (including anti-reflection film) in a multilayer resist film, a polymer having a chemical structure in which the repeating unit (1) which is to be alkali-soluble after resolution with an acid is eliminated from the chemical structure of the resin contained in the positive type radiation sensitive resin composition for forming a resist as mentioned above may be used. The contents of the repeating units are not particularly limited and may be selected properly according to the object used for the resulting coating film. Generally, the content of the repeating unit (2) is selected from a range from 10% to 100% by mol, and the content of the repeating unit (3) is selected from a range from 0% to 90% by mol.

In the case where the upper layer film and under layer film in the multilayer resist film are used for an anti-reflection film, the resin is required to have a crosslinking point and a chemical structure capable of absorbing the radiation emitted in photolithography. Example of the crosslinking point includes a reactive substituent capable of crosslinking with an ester bond, urethane bond or the like, such as hydroxyl group, amino group, carboxyl group and epoxy group. As the monomer having the reactive substituent to be the crosslinking point, a hydroxyl styrene such as p-hydroxystyrene and m-hydroxystyrene as well as a monomer having a reactive substituent such as hydroxyl group, amino group, carboxyl group and epoxy group may be properly used.

The chemical structure absorbing radiation depends on the wavelength of the radiation employed. For example, when the radiation is an ArF excimer laser light, a chemical structure having a benzene ring or the related thereof is preferably used. Examples of the monomer having the chemical structure include a styrene such as styrene, α-methylstyrene, p-methylstyrene, p-hydroxystyrene and m-hydroxystyrene, or its derivative; an aromatic ester having ethylenic double bond such as substituted or non-substituted phenyl (meth)acrylate, substituted or non-substituted naphthalene(meth)acrylate, and substituted or non-substituted anthracene(meth)acrylate; and the like. The monomer having a chemical structure absorbing radiation, may be used for the introduction into either the repeating unit (2) or (3) whether the monomer has a polar group or nonpolar group. The content derived from the monomer having a chemical structure absorbing radiation is preferably selected from the range from 10% to 100% by mol. It is noted that “(meth)acrylate” means acrylate and methacrylate in the specification.

Further, the resin solution can be prepared by polymerizing the above-mentioned polymerizable compound (namely, the polymerizable unsaturated monomer) using an initiator, and if necessary, in the presence of a chain transfer agent in a proper solvent.

Examples of the polymerization initiator include a radical initiator such as an azo compound including 2,2-azobisisobutyronitrile, 2,2′-azobis(2-methylbutyronitrile), dimethyl 2,2′-azobis(2-methylpropionate), 1,1′-azobis(cyclohexane-1-carbonitrile), 4,4′-azobis(4-cyanovaleric acid) and the like, an organic peroxide including decanoyl peroxide, lauroyl peroxide, benzoyl peroxide, bis(3,5,5-trimethylhexanoyl) peroxide, peroxysuccinic acid, 2-ethylhexaneperoxoic acid tert-butyl and the like. The polymerization initiator may be used singly or in combination of two or more types thereof.

Examples of the chain transfer agent include a thiol compound such as dodecyl mercaptan, mercaptoethanol, mercaptopropanol, mercaptoacetic acid, mercaptopropionic acid and 4,4-bis(trifluoromethyl)-4-hydroxy-1-mercaptobutane. The chain transfer agent may be used singly or in combination of two or more types thereof.

The amounts of the polymerization initiator and the chain transfer agent to be used may be properly selected depending on types of the starting monomer (polymerizable compound) for polymerization, polymerization initiator, and chain transfer agent, polymerization temperature, polymerization solvent, method for polymerization, purification condition or the like.

Generally, if the weight average molecular weight of the resin is too high, its solubility in the solvent used in film forming or the alkali developer tends to be poor. On the other hand, if the weight average molecular weight of the resin is too low, the performance of the coating film tends to be reduced. Therefore, the polystyrene conversion weight average molecular weight of the resin (hereinafter, referred to as “Mw”) as measured by gel permeation chromatography (GPC) is preferably adjusted to be in the range from 2,000 to 40,000, more preferably from 3,000 to 30,000.

Additionally, examples of the solvent (polymerization solvent) used for the polymerization include a ketone compound such as acetone, methyl ethyl ketone, methyl amyl ketone and cyclohexanone; an ether compound such as tetrahydrofuran, dioxane, glyme and propylene glycol monomethylether; an ester compound such as ethyl acetate and ethyl lactate; an ether ester compound such as propylene glycol monomethylether acetate; a lactone compound such as γ-butyrolactone; and the like. The solvent may be used singly or in combination of two or more types thereof.

The amount of the solvent to be used is not particularly limited and is usually in the range from 0.5 to 20 parts by weight, and preferably from 1 to 10 parts by weight based on 1 part by weight of the monomer. If the amount of the solvent used is too small, the monomer may be deposited or the viscosity of the resin may be too high to maintain uniformity of the polymerization system. On the other hand, if the amount of solvent used is too large, the conversion of the starting monomer may be insufficient or the desirable molecular weight of the resulting resin may not be attained.

The reaction conditions in the polymerization are not particularly limited. The reaction temperature is set to be usually in the range from 40° C. to 120° C., and preferably from 50° C. to 100° C. The reaction time is set to be usually in the range from 1 to 48 hours, and preferably from 1 to 24 hours.

Further, the concentration of the resin (solid concentration) in the resin solution obtained in the resin solution preparation process is preferably in the range from 1% to 80% by weight, more preferably from 5% to 50% by weight, and further preferably from 10% to 50% by weight.

### [2] Purification Process

In the purification process, the resin solution containing the photoresist resin is subjected to ultrafiltration using an ultrafilter membrane for removing impurities of a low molecular component such as remaining monomer, dimer, trimer and oligomer, and purifying. The analysis of the low molecular component can be performed using high performance liquid chromatography (HPLC).

The ultrafilter membrane is preferably an ultrafilter membrane made of a ceramic from the viewpoint of suppressing the contamination with impurities originating in the membrane component to the resin solution.

The form of the ultrafilter membrane is not particularly limited and is preferably a circular cylinder type and an angular cylinder type (such as tubular film type and honey comb film type) that have one or more through holes.

Additionally, the structure of the ultrafilter membrane is not particularly limited. The ultrafilter membrane may have (1) a three layer structure consisting of a membrane layer, middle layer and substrate, (2) a two layer structure consisting of a membrane layer and substrate, (3) a single layer structure consisting of only a membrane layer, and the like.

The material of the membrane layer may be TiO₂, ZrO₂, Al₂O₃ and the like. Among these, TiO₂ and ZrO₂ are preferable since they have fine pores, and provide an ultrafilter membrane having high strength.

The material of the middle layer may be TiO₂, ZrO₂, Al₂O₃ and the like. The material of the substrate may be TiO₂, ZrO₂, Al₂O₃ and the like. Among these, Al₂O₃ is preferable.

Further, the average pore size of the ultrafilter membrane is preferably 10 nm or smaller, more preferably in the range from 3 to 10 nm, and further preferably from 4 to 8 nm. When the average pore size of the ultrafilter membrane is 10 nm or smaller, the dissolving out of the resin component from the resin solution can be prevented. In addition, when the average pore size of the ultrafiltration film is 3 nm or larger, impurities such as low molecular weight components in the resin solution can be sufficiently removed.

It is noted that the “average pore size” is a value measured by a method according to JIS R1655 (Test method which can determine the pore size distribution of molded fine ceramics using the mercury penetration method).

In the purification process according to the present invention, (1) the impurities in the resin solution may be removed by supplying a solvent continuously into the solvent tank of the purification apparatus, and making the resin solution contact with the ultrafilter membrane continuously maintaining the surface level of the solvent in the tank constantly (namely, maintaining the volume of the resin solution in the tank), and (2) the impurities in the resin solution may be removed by supplying a solvent into the solvent tank of the purification apparatus, and repeating alternately a concentration process for concentrating the resin solution while removing impurities in the resin solution using the ultrafilter membrane, and a dilution process for diluting the concentrated resin solution with a solvent. The preferable method is the purification method (2) wherein the concentration process and the dilution process are repeated alternately, since the amount of the solvent to be used can be reduced and the removal rate of the impurities in the resin solution can be effectively improved.

The conditions for the ultrafiltration may be properly selected according to the concentration of the resin in the resin solution and the like. For instance, the linear velocity of the resin solution in the ultrafilter membrane in the purification process is preferably in the range from 0.1 to 5 m/s, more preferably from 0.1 to 4 m/s, and further preferably from 0.5 to 3.5 m/s. In the case where the linear velocity of the resin solution is in the range from 0.1 to 5 m/s, impurities such as low molecular weight components and metal components can be effectively removed.

Additionally, when the linear velocity of the resin solution is 2.5 m/s or smaller (preferably in the range from 0.1 to 2.5 m/s, more preferably from 0.5 to 2.5 m/s, and further preferably from 0.5 to 1.0 m/s), the polymer recovery can be dramatically improved.

Further, the filtration time (the total filtration time through the purification process) is preferably in the range from 30 minutes to 100 hours, more preferably from 1 to 50 hours, and further preferably from 1 to 30 hours.

In the concentration process, the resin solution is concentrated so as to be the concentration of the resin (solid content) preferably in the range from 28% to 60% by weight, more preferably from 28% to 50% by weight, and further preferably from 28% to 40% by weight.

Additionally, in the dilution process, the resin solution diluted so as to be the concentration of the resin preferably in the range from 5% to 25% by weight, more preferably from 10% to 25% by weight, and further preferably from 10% to 20% by weight.

The difference between the concentration of the concentrated resin solution and the concentration of the diluted resin solution is preferably in the range from 3% to 55% by weight, more preferably from 3% to 40% by weight, and further preferably from 8% to 30% by weight.

The repeating number of the concentration process and dilution process is not particularly limited and is preferably set to be in the range from 1 to 50 times, more preferably from 1 to 30 times, and further preferably from 1 to 10 times. When the repeating number is in the range from 1 to 50 times, the impurities in the resin solution may be sufficiently removed.

As the solvent for the purification process, a similar solvent to the solvent for the polymerization can be used. The solvent used in the purification process may be the same as that used in the resin solution preparation process, or may be different from the solvent used in the resin preparation process. The same solvent in both these processes is preferably used from the view point of the easiness of the separation during recovery by separating the impurities and solvent from the waste solvent produced in the purification process.

In the present invention, after the waste solvent (namely, the solvent containing impurities) produced in the purification process is distilled to separate the impurities, the resulting waste solvent containing no impurities can be reused. More precisely, the impurities may be separated from the waste solvent produced in the purification process by fractional distillation, using the difference between the boiling points, and the resulting solvent can be reusable as a solvent for polymerization, or a solvent for use in the purification process (especially as a dilution solvent in the dilution process). In this case, the method enables substantial reduction in the amount of solvent necessary for the preparation of a photoresist resin.

### EXAMPLES

Hereinafter, the embodiments of the present invention are described in detail using Examples. The present invention is in no way limited by these Examples.

### Example 1

865 g of methyl ethyl ketone (MEK) as a polymerization solvent was put into a 5,000 ml three-neck flask with a Dimroth condenser, the flask was completely purged with nitrogen gas, and then the contents in the flask were heated to a temperature of 80° C. while stirring with a mixer powered by Three-one motor. After that, a solution in which 355 g of 5-methacryloyloxy-2,6-norbornanecarbolactone (NLM) and 470 g of 2-methyl-2-adamantylmethacrylate (MAdMA) were dissolved in 1,680 g of MEK, and a solution in which 14.8 g of azobisisobutyronitrile was dissolved in 74 g of MEK were dropped into the flask using the dropping funnel over 3 hours. After the dropping, the contents were aged for 3 hours and cooled to room temperature to prepare a resin solution.

The resin solution was subjected to high performance liquid chromatography. The conversion of the monomer was 90%, and the amount of the remaining monomer was about 11% by weight based on 100% by weight of the resin. Additionally, weight-average molecular weight (Mw) and number-average molecular weight (Mn) of the resulting resin were measured, and the molecular weight distribution (distribution degree Mw/Mn) was 1.73.

Subsequently, 1,000 g of the resulting resin solution (resin concentration: about 25% by weight) was put into a solution tank provided in the purification apparatus (“Ultra filtration nanofilter demi” manufactured by Noritake Co., Ltd., Type Name “1P7-250-50NM”) and the resin solution was subjected to ultrafiltration for the concentration until the resin concentration becomes 30% by weight, using a ceramic made ultrafilter membrane (manufactured by STC Co., Ltd., Trade Name “MEMBER ALOX”, average pore size: 5 nm, differential molecular weight: 1,000, membrane layer: TiO₂, middle layer and substrate: Al₂O₃, size: diameter 10 mm×length 250 mm, membrane form: diameter 7 mm×1 hole, membrane area: 0.0055 m²). The conditions for the ultrafiltration were as follows: linear velocity; 3 m/s, filtration time; 6 hours.

The resin solution concentrated to be a resin concentration of 30% by weight was diluted with a dilution solvent (MEK) so as to be a resin concentration of 15.2% by weight, and then the ultrafiltration was performed on the resulting diluted resin solution until the resin concentration attains 30% by weight. The conditions for the ultrafiltration were as follows: linear velocity; 3 m/s, filtration time; 10 hours. This operation was repeated 9 times to purify the resin solution.

In this operation, the total amount of MEK used as the dilution solvent was 3,760 g. The resulting resin solution was subjected to high performance liquid chromatography. The remaining monomer was determined to be 0.04% by weight based on 100% by weight of the resin and the molecular weight distribution was 1.30.

Mw and Mn were values determined in the following manner.

These were measured by gel permeation chromatography (GPC) with monodispersed polystyrene as a standard reference material using GPC column (“G2000HXL”×2, “G3000HXL”×1, “G4000HXL”×1) manufactured by Tosoh Corp. under the following analysis conditions. Flow rate: 1.0 ml/min., eluate tetrahydrofuran, column temperature: 40° C.

### Example 2

The waste solvent produced during the purification process in Example 1 (MEK solution containing impurities such as low molecular component) was put into a round bottom 5,000 ml flask. Then the content was boiled at the normal pressure to distill the solvent and separate its impurities until the amount of the remaining solvent was reduced to 10% by volume of the initial amount to collect a distillate (MEK) containing no impurities. The collecting process was performed three times, and a total of 3,380 g of solvent (MEK) was recovered from about 3,800 g of the waste solvent.

After that, a resin solution (resin concentration: about 25% by weight) was prepared in the same manner as Example 1. 1,000g of the resulting resin solution was put into the solution tank provided in the purification apparatus, and the ultrafiltration was performed for concentration using a ceramic ultrafilter membrane until the resin concentration becomes 30% by weight.

The resin solution concentrated to be a resin concentration of 30% by weight was diluted with a dilution solvent (MEK) so as to be a resin concentration of 15.2% by weight, and then the ultrafiltration was performed on the resulting diluted resin solution until the resin concentration attains 30% by weight. The conditions for the ultrafiltration were as follows: linear velocity; 3 m/s, filtration time: 10 hours. This operation was repeated 9 times to purify the resin solution.

The total amount of MEK used in this operation was 3,760 g. In this MEK, 3,380 g of MEK was recovered one as described above.

The resulting resin solution was subjected to high performance liquid chromatography. The remaining monomer was determined to be 0.05% by weight based on 100% by weight of the resin and the molecular weight distribution was 1.32.

### Comparative Example 1

A resin solution (resin concentration: about 25% by weight) was prepared in the same manner as Example 1. 5,000 g of methanol was added to 1,000 g of the resulting resin solution to reprecipitate the resin.

After that, the resulting aggregate was filtrated and recovered. 1,000 g of methanol was further used for repulping, and this repulping operation was repeated twice to purify the resin solution.

The total amount of the solvent (methanol) used for this purification was 7,000 g. The resulting resin solution was subjected to high performance liquid chromatography. The remaining monomer was determined to be 0.1% by weight based on 100% by weight of the resin and the molecular weight distribution was 1.45.

### Example 3

865 g of methyl ethyl ketone (MEK) as a polymerization solvent was put into a 5,000 ml three-neck flask with a Dimroth condenser, the flask was completely purged with nitrogen gas, and then the contents in the flask were heated to a temperature of 80° C. while stirring with a mixer powered by Three-one motor. After that, a solution in which 355 g of 5-methacryloyloxy-2,6-norbornanecarbolactone (NLM) and 470 g of 2-methyl-2-adamantylmethacrylate (MAdMA) were dissolved in 1,680 g of MEK, and a solution in which 14.8 g of azobisisobutyronitrile was dissolved in 74 g of MEK were dropped into the flask using the dropping funnel over 3 hours. After the dropping, the contents were aged for 3 hours and cooled to room temperature to prepare a resin solution.

The resin solution was subjected to high performance liquid chromatography. The conversion of the monomer was 87%, and the amount of the remaining monomer was about 15% by weight based on 100% by weight of the resin. Additionally, weight-average molecular weight (Mw) and number-average molecular weight (Mn) of the resulting resin were measured, and the molecular weight distribution (distribution degree Mw/Mn) was 1.80.

Subsequently, 1,000 g of the resulting resin solution (resin concentration: about 25% by weight) was put into a solution tank provided in the same purification apparatus as in Example 1. The resin solution was subjected to ultrafiltration for the concentration until the resin concentration becomes 30% by weight, using a ceramic made ultrafilter membrane (manufactured by NGK INSULATORS, LTD. Trade Name “CeLilt”, average pore size: 4 nm, membrane layer: TiO₂, middle layer and substrate: Al₂O₃, size: diameter 3 mm×37 holes×length 150 mm, membrane area: 0.052 m²). The conditions for the ultrafiltration were as follows; linear velocity; 1 m/s, filtration time 1.5 hours.

The resin solution concentrated to be a resin concentration of 30% by weight was diluted with a dilution solvent (MEK) so as to be a resin concentration of 15.2% by weight, and then the ultrafiltration was performed on the resulting diluted resin solution until the resin concentration attains 30% by weight. The conditions for the ultrafiltration were as follows: linear velocity; 1 m/s, filtration time: 3 hours. This operation was repeated 9 times to purify the resin solution.

In this operation, the total amount of MEK used as the dilution solvent was 3,850 g. The resulting resin solution was subjected to high performance liquid chromatography. The remaining monomer was determined to be 0.05% by weight based on 100% by weight of the resin and the molecular weight distribution was 1.52.

### Example 4

1,000 g of a resin solution (resin concentration: about 25% by weight) obtained in the same manner as in Example 3 was put into a solution tank provided in the same purification apparatus as in Example 1. The resin solution was subjected to ultrafiltration for the concentration until the resin concentration becomes 30% by weight, using a ceramic made ultrafilter membrane (manufactured by NGK INSULATORS, LTD. Trade Name “CeLilt”, average pore size: 4 nm, membrane layer: TiO₂, middle layer and substrate: Al₂O₃, size: diameter 3 mm×19 holes×length 500 mm, membrane area: 0.174 m²). The conditions for the ultrafiltration were as follows; linear velocity; 1 m/s, filtration time; 1.0 hours.

The resin solution concentrated to be a resin concentration of 30% by weight was diluted with a dilution solvent (MEK) so as to be a resin concentration of 15.2% by weight, and then the ultrafiltration was performed on the resulting diluted resin solution until the resin concentration attains 30% by weight. The conditions for the ultrafiltration were as follows: linear velocity; 1 m/s, filtration time: 1.0 hours. This operation was repeated 7 times to purify the resin solution.

In this operation, the total amount of MEK used as the dilution solvent was 3,880 g. The resulting resin solution was subjected to high performance liquid chromatography. The remaining monomer was determined to be 0.05% by weight based on 100% by weight of the resin and the molecular weight distribution was 1.50.

Further, the solid content in the polymer solution after ultrafiltration was determined, and the polymer recovery was 73%.

### Comparative Example 2

A resin solution (resin concentration: about 25% by weight) was prepared in the same manner as Example 3. 5,000 g of methanol was added to 1,000 g of the resulting resin solution to reprecipitate the resin.

After that, the resulting aggregate was filtrated and recovered. 1,000 g of methanol was further used for repulping, and this repulping operation was repeated twice to purify the resin solution.

In this operation, the total amount of MEK used as the dilution solvent was 7,000 g. The resulting resin solution was subjected to high performance liquid chromatography The remaining monomer was determined to be 0.1% by weight based on 100% by weight of the resin and the molecular weight distribution was 1.63.

The resin solutions (after purification) in Example 3 and Comparative Example 2 were subjected to ICP-MS to measure the concentrations of remaining metal components shown in Table 1, using the apparatus “ELAN DRC plus” manufactured by Perkin Elmer Inc. The results are shown in Table 1.

TABLE 1

| | Concentration of remaining metal component (ppb) | | | | | | | | | | | | | | | |
|---|---|---|---|---|---|---|---|---|---|---|---|---|---|---|---|---|
| | Na | Mg | Ca | Fe | Al | K | Cr | Ni | Cu | Zn | Ti | Mn | Li | Zr | Pb | Sn |
| Example 3 | 4.1 | 5.2 | 8.1 | 6.3 | 1.3 | 3.3 | 1.1 | 0.6 | <0.5 | 2.2 | <0.5 | <0.5 | 2.7 | <0.5 | 1.0 | <0.5 |
| Comparative | 41 | 9.6 | 9.5 | 9.7 | 2.1 | 4.2 | 4.2 | 2.5 | 0.7 | 8.2 | <0.5 | 0.7 | 5.4 | <0.5 | 7.4 | 1.0 |
| Example 2 | | | | | | | | | | | | | | | | |

777 g of methyl ethyl ketone (MEK) as a polymerization solvent was put into a 5,000 ml three-neck flask with a Dimroth condenser, the flask was completely purged with nitrogen gas, and then the contents in the flask were heated to a temperature of 80° C. while stirring with a mixer powered by Three-one motor. After that, a solution in which 426 g of 5-methacryloyloxy-2,6-norbornanecarbolactone (NLM), 84 g of tricyclo[5.2.1.0^{2,6}]decane-8-yl methacrylate (DCM) and 279 g of ethylcyclopentyl methacrylate (ECpMA) were dissolved in 1,381 g of MEK, and a solution in which 43 g of azobisisobutyronitrile was dissolved in 170 g of MEK were dropped into the flask using the dropping funnel over 3 hours. After the dropping, the contents were aged for 3 hours and cooled to room temperature to prepare a resin solution.

The resin solution was subjected to high performance liquid chromatography. The conversion of the monomer was 96%, and the amount of the remaining monomer was about 4% by weight based on 100% by weight of the resin. Additionally, weight-average molecular weight (Mw) and number-average molecular weight (Mn) of the resulting resin were measured, and the molecular weight distribution (distribution degree Mw/Mn) was 1.90.

After that, 1,000 g of the resulting resin solution (resin concentration: about 25% by weight) was subjected to the ultrafiltration in the same manner as in Example 4, and the resin solution was purified.

In this operation, the total amount of MEK used as the dilution solvent was 4,170 g. The resulting resin solution was subjected to high performance liquid chromatography. The remaining monomer was determined to be 0.03% by weight based on 100% by weight of the resin and the molecular weight distribution was 1.50.

### Comparative Example 3

A resin solution (resin concentration: about 25% by weight) was prepared in the same manner as Example 5. 10,000 g of methanol was added to 1,000 g of the resulting resin solution to reprecipitate the resin.

After that, the resulting aggregate was filtrated and recovered. 1,000 g of methanol was further used for repulping, and this repulping operation was repeated twice to purify the resin solution.

In this operation, the total amount of MEK used as the dilution solvent was 12,000 g. The resulting resin solution was subjected to high performance liquid chromatography. The remaining monomer was determined to be 0.05% by weight based on 100% by weight of the resin and the molecular weight distribution was 1.70.

The resin solutions (after purification) in Example 5 and Comparative Example 3 were subjected to ICP-MS in the same manner as described above to measure the concentrations of remaining metal components shown in Table 2. The results are shown in Table 2.

TABLE 2

| | Concentration of remaining metal component (ppb) | | | | | | | | | | | | | | | |
|---|---|---|---|---|---|---|---|---|---|---|---|---|---|---|---|---|
| | Na | Mg | Ca | Fe | Al | K | Cr | Ni | Cu | Zn | Ti | Mn | Li | Zr | Pb | Sn |
| Example 5 | 2.9 | 4.5 | 6.4 | 4.5 | 2.1 | 2.0 | 0.6 | <0.5 | <0.5 | 1.6 | <0.5 | <0.5 | 0.9 | <0.5 | <0.5 | <0.5 |
| Comparative | 6.8 | 6.6 | 7.5 | 6.5 | 2.5 | 4.4 | 8.2 | 1.2 | <0.5 | 8.3 | <0.5 | 0.5 | 2.2 | <0.5 | <0.5 | <0.5 |
| Example 3 | | | | | | | | | | | | | | | | |

777 g of methyl ethyl ketone (MEK) as a polymerization solvent was put into a 5,000 ml three-neck flask with a Dimroth condenser, the flask was completely purged with nitrogen gas, and then the contents in the flask were heated to a temperature of 80° C. while stirring with a mixer powered by Three-one motor. After that, a solution in which 357 g of 5-methacryloyloxy-2, 6-norbornanecarbolactone (NLM), 96 g of ethylcyclopentyl methacrylate (ECpMA) and 319 g of 2-methyl-2-adamantylmethacrylate (MAdMA) were dissolved in 1,423 g of MEK, and a solution in which 29 g of azobisisobutyronitrile was dissolved in 116 g of MEK were dropped into the flask using the dropping funnel over 3 hours. After the dropping, the contents were aged for 3 hours and cooled to room temperature to prepare a resin solution.

The resin solution was subjected to high performance liquid chromatography. The conversion of the monomer was 91%, and the amount of the remaining monomer was about 10% by weight based on 100% by weight of the resin. Additionally, weight-average molecular weight (Mw) and number-average molecular weight (Mn) of the resulting resin were measured, and the molecular weight distribution (distribution degree Mw/Mn) was 1.67.

After that, 1,000 g of the resulting resin solution (resin concentration: about 25% by weight) was subjected to the ultrafiltration in the same manner as in Example 4, and the resin solution was purified.

In this operation, the total amount of MEK used as the dilution solvent was 4,250 g. The resulting resin solution was subjected to high performance liquid chromatography. The remaining monomer was determined to be 0.04% by weight based on 100% by weight of the resin and the molecular weight distribution was 1.45.

### Comparative Example 4

A resin solution (resin concentration: about 25% by weight) was prepared in the same manner as Example 6. 5,000 g of methanol was added to 1,000 g of the resulting resin solution to reprecipitate the resin.

After that, the resulting aggregate was filtrated and recovered. 1,000 g of methanol was further used for repulping, and this repulping operation was repeated twice to purify the resin solution.

In this operation, the total amount of MEK used as the dilution solvent was 7,000 g. The resulting resin solution was subjected to high performance liquid chromatography. The remaining monomer was determined to be 0.08% by weight based on 100% by weight of the resin and the molecular weight distribution was 1.59.

### Example 7

1,000 g of a resin solution (resin concentration: about 25% by weight) obtained in the same manner as in Example 3 was put into a solution tank provided in the same purification apparatus as in Example 1. The resin solution was subjected to ultrafiltration for the concentration until the resin concentration becomes 30% by weight, using the same ultrafilter membrane as in Example 4. The conditions for the ultrafiltration were as follows; linear velocity; 4 m/s, filtration time; 0.5 hours.

Subsequently, the resin solution concentrated to be a resin concentration of 30% by weight was diluted with a dilution solvent (MEK) so as to be a resin concentration of 15.2% by weight, and then the ultrafiltration was performed on the resulting diluted resin solution until the resin concentration attains 30% by weight. The conditions for the ultrafiltration were as follows: linear velocity; 4 m/s, filtration time: 0.45 hours. This operation was repeated 9 times to purify the resin solution.

In this operation, the total amount of MEK used as the dilution solvent was 3,800 g. The resulting resin solution was subjected to high performance liquid chromatography. The remaining monomer was determined to be 0.03% by weight based on 100% by weight of the resin and the molecular weight distribution was 1.40.

Further, the solid content in the polymer solution after ultrafiltration was determined, and the polymer recovery was 66%.

### Example 8

1,000 g of a resin solution (resin concentration: about 25% by weight) obtained in the same manner as in Example 3 was put into a solution tank provided in the same purification apparatus as in Example 1. The resin solution was subjected to ultrafiltration for the concentration until the resin concentration becomes 30% by weight, using the same ultrafilter membrane as in Example 4. The conditions for the ultrafiltration were as follows; linear velocity; 0.5 m/s, filtration time; 1.5 hours.

Subsequently, the resin solution concentrated to be a resin concentration of 30% by weight was diluted with a dilution solvent (MEK) so as to be a resin concentration of 15.2% by weight, and then the ultrafiltration was performed on the resulting diluted resin solution until the resin concentration attains 30% by weight. The conditions for the ultrafiltration were as follows: linear velocity; 0.5 m/s, filtration time: 2.0 hours. This operation was repeated 9 times to purify the resin solution.

In this operation, the total amount of MEK used as the dilution solvent was 3,800 g. The resulting resin solution was subjected to high performance liquid chromatography. The remaining monomer was determined to be 0.03% by weight based on 100% by weight of the resin and the molecular weight distribution was 1.50.

Further, the solid content in the polymer solution after ultrafiltration was determined, and the polymer recovery was 74%.

Clearly from the results above, it is found that the amount of solvent to be used can be reduced, and that impurities such as low molecular components and metal components can be effectively removed, and that a resin having a narrow molecular weight distribution can be easily prepared in the method for the production of the photoresist resin according to the Examples.

Additionally, it is surprisingly found that the polymer recovery is dramatically improved when the linear velocity of the resin solution in the ultrafilter membrane in the purification process is lowered (refer to Example 4, 7, and 8).

1. A method for production of a photoresist resin by polymerizing a polymerizable compound in the presence of a solvent, characterized by comprising,
(1) a resin solution preparation process in which a resin solution containing a photoreist resin is prepared, and
(2) a purification process in which said resin solution is purified using a ultrafilter membrane.

2. The method for production of a photoresist resin according to claim 1, wherein said ultrafilter membrane comprises a ceramic.

3. The method for production of a photoresist resin according to claim 1, wherein the membrane layer of said ultrafilter membrane comprises TiO₂ or ZrO₂.

4. The method for production of a photoresist resin according to claim 1, wherein the average pore size of said ultrafilter membrane is 10 nm or smaller.

5. The method for production of a photoresist resin according to claim 1, wherein said purification process comprises a concentration process for concentrating said resin solution while removing impurities in said resin solution using said ultrafilter membrane, and a dilution process for diluting said concentrated resin solution with a solvent, these processes being repeated alternately.

6. The method for production of a photoresist resin according to claim 1, wherein the waste solvent produced in said purification process is distilled to separate impurities, after which the resulting waste solvent from which said impurities have been separated is then reused as said solvent.

7. The method for production of a photoresist resin according to claim 1, wherein the linear velocity of said resin solution in said ultrafilter membrane during said purification process is 2.5 m/s or smaller.
